(19) United States
(12) Patent Application Publication
(10) Pub. No.: US 2026/0158414 A1
(43) Pub. Date: Jun. 11, 2026

(54) METHOD AND DEVICE FOR EXTRACTION

(71) Applicant: Harburg-Freudenberger Maschinenbau GmbH, Hamburg (DE)

(72) Inventor: Moritz VÖLTZER, Hamburg (DE)

(21) Appl. No.: 18/707,994

(22) PCT Filed: Aug. 17, 2022
(86) PCT No.: PCT/DE2022/100610

§ 371 Date: May 7, 2024

(30) Foreign Application Priority Data
Nov. 8, 2021 (DE) 10 2021 128 991.2

(51) Int. Cl. B01D 11/02

(52) U.S. Cl. CPC B01D 11/0269; B01D 11/028; B01D 11/0288

(57) ABSTRACT

A method and a device for extraction in which an extraction agent that is highly volatile at atmospheric pressure is used, which is easier to remove from the extracted oil or the press cake compared to the hexane. The extraction is carried out at an overpressure so that the extraction agent is liquid at the desired process temperatures.

The invention relates to a device for extracting oil from press cake or oilseeds.

The invention also relates to a method for extracting oil from press cake or oilseeds.

According to known methods for extracting oil from oil-containing seeds or press cake, hexane is used as the extraction agent, which is combined with the press cake in an extractor. Lurgi band extractors, for example, are used as extractors.

Before extraction, the pressed material, such as oily seeds, is usually pre-pressed using a suitable press. After pre-pressing, the press cake usually still has a residual fat content of around 20%. Extraction carried out after pre-pressing can reduce the residual fat content in the press cake to around 1%.

During extraction using a Lurgi band extractor, the seed or press cake is fed to the extractor via a feed screw that encapsulates the extractor from the surrounding atmosphere. A circulating chain with compartments for the seed or press cake runs through the extractor. The bottom of these compartments is perforated so that the extraction agent sprayed onto these compartments or the press cake in them can drain off together with the extracted oil. The extraction agent loaded with oil is also called miscella. This miscella is collected and drained from the extractor. It is common practice to recirculate the miscella inside the extractor before draining. After passing through the extractor, the seed or pre-press cake, whose oil content has now been significantly reduced, is conveyed out of the extractor using a screw conveyor that encapsulates the extractor from the surrounding atmosphere. The extractor is usually operated at a slight negative pressure (a few mbar) to prevent the extractant from entering the surrounding atmosphere.

After treatment in the extractor, the press cake has a mass fraction of approx. 30 % of the extraction agent. This must be removed from the cake for further utilization of the press cake, as it is toxic in the case of hexane and is also to be used again as an extraction agent.

For this purpose, the press cake containing the extraction agent is often placed in a toaster dryer cooler (TTK), which is similar to a heating pan with several levels through which the cake passes from top to bottom. The press cake undergoes the following processes: Predesolventization by heating surfaces heated with steam, desolventization and heat treatment (toasting) by heating surfaces as well as by blowing in direct steam and expelling moisture using heated, dry air and then cooling the material with ambient air. In conventional operation of such a TTK at atmospheric pressure, i.e. ambient pressure of around 1.013 bar a (absolute pressure), the temperature of the cake already has to be increased to over 69° C. in order to vaporize the hexane. Much higher temperatures are actually used to increase efficiency. Temperatures between 75 and 120° C. are common. The press cake therefore has a long residence time at high temperatures when the extraction agent is removed.

The miscella is usually separated into oil and extractant using a distillation process. Although the distillation, in which the more volatile hexane is removed in gaseous form, takes place under negative pressure, the oil must be heated to temperatures of over 100° C.

There is growing interest in a processing method that enables a high PDI value (Protein Dispersibility Index) in the press cake in order to produce the highest possible quality animal feed or dietary supplements. The PDI value stands for the solubility of the proteins in the press cake, which is negatively influenced by the protein denaturation that occurs at high temperatures.

There is also an interest in mustard oil that contains as much allyl isothiocyanate (AITC) as possible, which causes a pungent taste. The AITC content also decreases with increasing temperatures during processing. A target value of around 0.3 meq AITC can be expected at a maximum oil temperature of around 70° C.

For both of the aforementioned objectives, it is therefore necessary to minimize the temperature during the entire process. In particular, the temperature should not exceed 60° C. if possible, as otherwise the PDI value in the press cake and/or the AITC content in the oil will be significantly reduced.

At the same time, the lowest possible residual fat content in the press cake is generally desired. However, it is not possible to achieve this combination of objectives with the known extraction devices and processes.

It is therefore an object of the invention to provide a device for extraction which enables the required lower process temperatures of maximum 60° C.

According to the invention, this object is achieved by a device for extraction according to patent claim 1.

It is a further an object of the invention to provide a process for extraction which enables the required lower process temperatures of maximum 60° C.

According to the invention, this object is achieved by a method of extraction according to claim 5.

Advantageous embodiments of the invention are claimed in the dependent patent claims.

The following disclosed features of a device for extraction and a method for extraction each form part of the invention in all practicable combinations.

The extraction agent for use in a device for extraction according to the invention and used with a method for extraction according to the invention should ideally have the following properties:

It must be able to extract the oil from the cake. It should be as non-toxic as possible. It should be available as easily and inexpensively as possible. It should be able to be pumped into the extractor in a liquid aggregate state at approx. 60° C. Under the pressure and temperature conditions prevailing in the extractor, the extractant should be in a liquid state until it leaves the extractor. Due to the change in pressure on leaving the extractor, the extracting agent should vaporize almost immediately and as completely as possible. It should be possible to condense the extractant as easily as possible for recovery from the exhaust air flow.

Due to the desired condensation from the exhaust air flow and the required flash evaporation when leaving the separator, there is a contradiction here, so that a compromise solution is required with regard to the required properties.

The extraction agent used in a device according to the invention for extraction and used with a method according to the invention for extraction is designed according to the invention as a fat dissolver in order to dissolve oils from the press cake.

The extraction agent is advantageously at least partially non-polar, preferably completely non-polar.

For optimum usability of the extraction agent, this is preferably selected so that it is liquid at the temperatures and pressures prevailing in the extraction device during operation and is gaseous at the atmospheric pressure or ambient pressure of about 1.013 bar a (absolute pressure) prevailing outside the extraction device, so that the extraction agent vaporizes as completely as possible on or shortly after leaving the extraction device.

This significantly simplifies the removal of the extraction agent from the press cake.

However, embodiments are also possible in which the extraction agent vaporizes before leaving the extraction device.

Preferably, the extraction agent has a vapor pressure of 1.1-7 bar a at 60° C. This ensures that the extraction agent vaporizes safely due to the pressure drop after leaving the extraction device and is preferably still liquid at least until shortly before leaving the device.

The temperature of 60° C. corresponds to the target temperature of the press cake in the extraction device. Accordingly, the extraction agent has approximately the same temperature when it exits the extraction device. If a different, in particular a higher target temperature or process temperature is selected, the extraction agent may have to be adjusted so that the vapor pressure is correctly selected for the corresponding effect according to the invention. The relevant temperature range for the process temperature and thus the target temperature of the press cake is between about 50° C. and 90° C., in embodiments of the invention between about 50° C. and 80° C., particularly preferably between 50° C. and 70° C.

The process temperature is preferably between around 50° C. and 60° C. The lower limit is determined in particular by the desired minimum yield, as the viscosity of the oil increases at lower temperatures, making it more difficult to separate from the press cake. The upper limit is determined in particular by qualitative demands on the oil and/or the press cake and the associated maximum temperatures during extraction. In embodiments of the invention, the extraction agent is selected as n-butane and/or isopentane.

At 60° C. and atmospheric pressure, isopentane has an enthalpy of vaporization of 316 KJ/kg and n-butane of 319 KJ/kg. The vapor pressure of isopentane at 60° C. is 2.8 bar a and of n-butane 6.44 bar a. The condensation temperature of isopentane at atmospheric pressure is 28° C. and of n-butane −0.5° C.

For good extraction efficiency, the extraction agent in the extraction device must come into contact with the press cake in a liquid state. For this purpose, at least with regard to the use of extraction agents according to the invention with a vapor pressure above atmospheric pressure at the desired process temperature, it is necessary to generate and maintain an overpressure in the extraction device.

At a desired operating temperature of 60° C., a pressure of at least 2.8 bar a must be generated and maintained in the extraction device when isopentane is used as the extraction agent and at least 6.44 bar a when n-butane is used.

Accordingly, an extraction device according to the invention has an extraction chamber designed as an encapsulated overpressure chamber in which the extraction agent comes into contact with the press cake in liquid form.

The overpressure for the intended process temperature and the respective extraction agent used can be generated and maintained within the overpressure chamber using appropriate means.

In one embodiment of the invention, the overpressure chamber is designed in conjunction with the corresponding means for generating and maintaining a pressure in a pressure range greater than or equal to 1.1 bar a.

In a particularly preferred embodiment of the invention, the overpressure chamber is designed in conjunction with the corresponding means for generating and maintaining a pressure in a pressure range greater than or equal to 2.8 bar a.

In an advantageous embodiment particularly suitable for the use of isopentane as an extraction agent, the overpressure chamber is designed in conjunction with the corresponding means for generating and maintaining a pressure in a pressure range from about 3 bar a to about 3.5 bar a.

For the use of n-butane as an extraction agent, the overpressure chamber is designed in conjunction with the corresponding means in corresponding embodiments of the invention for generating and maintaining a pressure in a pressure range greater than or equal to 6.44 bar a, particularly preferably in a pressure range of about 6.6 bar a to 8.25 bar a.

In addition, an extraction device according to the invention has a feeding device for the press cake, a conveying device for the press cake within the extractor, an extraction agent feed, a press cake outlet device and a collecting device for miscella.

The feed device for press cake is preferably encapsulated so that the pressurized chamber of the extractor is encapsulated from the surrounding atmosphere and is designed, for example, as a feed screw.

The conveying device for the press cake within the pressurized chamber of the extractor is designed to convey the press cake and preferably has openings through which miscella can run off the press cake.

The press cake outlet device is preferably encapsulated so that the overpressure chamber of the extractor is sealed off from the surrounding atmosphere and is designed, for example, as a screw conveyor.

Furthermore, a device for extraction according to the invention has an extraction agent feed with which an extraction agent can be fed into the pressurized chamber.

In order to control the temperature of the extraction agent fed into the extractor, the extraction agent feed of an extraction device according to the invention has, in embodiments, a heat exchanger.

In order to control the quantity of extraction agent supplied, the extraction agent supply of an extraction device according to the invention has, in embodiments, an extraction agent metering unit, for example realized as a frequency-controlled pump and/or a control valve.

In embodiments, the process temperature in the extraction chamber is set by adjusting the temperatures of the supplied press cake/oilseeds and the extraction agent. In order to maintain the desired process temperature in the extraction chamber, the extraction chamber has thermal insulation in advantageous embodiments of the invention.

In advantageous embodiments of the invention, the device for extraction is equipped with a recovery device for the extraction agent. The extraction agent escaping and/or removed from the press cake and oil products can be collected and returned to a liquid state.

Preferably, the recovery device for the extraction agent has at least one condensation device for vapors containing the extraction agent, with which the extraction agent can be condensed.

The vapors containing the extraction agent are preferably collected with an aspiration system and fed to the condensation device.

In embodiments of the invention, the condensation device has a cooling unit, for example realized by a water cooling system or a chiller.

If an extraction agent with a particularly low condensation temperature is to be recycled, it is also possible to use a compressor to increase the pressure of the vapors containing the extraction agent, so that the condensation temperature increases.

The extraction agent-containing vapors can be collected both in the area of the extractor and in the area of any post-treatment facilities using an aspiration system.

In embodiments of the invention, the device for extraction is designed as a modified lurgi band extractor with an overpressure chamber. In alternative embodiments, constructions of the following types are also suitable: tubular belt extractor, small diameter round rotocell extractor.

In an extraction method according to the invention, a press cake or an oilseed is fed into a pressurized chamber of an extraction device.

In the overpressure chamber, the press cake or oilseed is brought into contact with a liquid extraction agent. In the overpressure chamber, an overpressure is generated and maintained that is greater than or equal to the vapor pressure of the extraction agent at the process temperature prevailing in the overpressure chamber.

As a result, the extraction agent remains in a liquid state in the pressurized chamber.

The process temperature is set depending on the desired target values with regard to the quality of the starting products press cake and oil and with regard to the extraction agent used and, if necessary, the duration of the extraction process.

In advantageous embodiments of the invention, the process temperature is in a range from 50° C. to 80° C. In preferred embodiments between 50° C. and 70° C. and in particularly preferred embodiments between 50° C. and 60° C.

A process temperature of 60° C. has proven to be particularly suitable in practical trials, as sufficiently efficient extraction with high product quality is possible through gentle treatment.

In order to prevent the formation of an explosive atmosphere in the extractor, in preferred embodiments of the invention an inert gas, for example nitrogen, is introduced into the extractor with the aid of an inert gas supply.

In particularly preferred embodiments of the invention, the inert gas supply is part of the means for generating an overpressure in the extraction chamber. The inert gas supply is designed to introduce an inert gas into the extraction chamber, so that the pressure in the extraction chamber can be increased by supplying the inert gas.

Particularly preferably, the inert gas supply is connected to a pressure control unit, by means of which the inert gas supply can be controlled, for example by activating a control valve and/or a pump depending on the target pressure, so that the process pressure in the extraction chamber can be adjusted with the aid of at least one pressure sensor.

An additional limitation of the pressure in the extraction chamber, in particular for safety purposes, is realized in embodiments of the invention by an overpressure valve preferably arranged in the upper region of the extraction chamber, through which gas can escape from the extraction chamber as soon as a pressure threshold value (for example 3.5 bar a for isopentane as extraction agent) is exceeded.

In embodiments of the invention, the miscella is recirculated in the extractor and continuously brought into contact with the press cake/oilseed.

Once the extraction process is complete, the press cake or oilseed is transported out of the overpressure chamber of the extraction device and the miscella is drained.

The extraction agent residues contained in the miscella and the press cake vaporize to a large extent at ambient pressure due to the selection of a highly volatile extraction agent in accordance with the invention. The press cake is cooled by the vaporization of the extraction agent.

In particular for lower capacities, the pressure extraction according to the invention can be carried out discontinuously in batch mode.

In embodiments of the invention, a residual fat content in the press cake of about 1% is realized, the residence time in the extractor being between about 60 minutes and about 90 minutes and the temperature in the extractor not falling below 50° C.

In particularly preferred embodiments of the invention, the residence time in the extractor is between about 60 minutes and 75 minutes.

In embodiments of the invention, post-treatment of the extracted oil and/or the press cake after extraction is carried out to ensure that the extraction agent residues are removed from the press cake and/or the oil as completely as possible.

The post-treatment of the press cake, which still contains about 30% extractant when it leaves the extractor, is realized in various embodiments of the invention according to the following options.

According to a first embodiment, the proportion of the extraction agent in the press cake is regulated to a minimum of about 10% by mechanical pressing, for example with a screw press. This is attractive in view of the fact that a mass fraction of less than 30% extraction agent may be sufficient for adequate cooling of the press cake during pressing and that mechanical pressing of the extraction agent is a simple way of reducing the mass fraction of extraction agent in the press cake compared to thermal separation by evaporation.

In order to avoid unwanted cooling of the press cake during mechanical desolventization, in embodiments of the invention this is to be carried out above the vapor pressure of the extraction agent. Alternatively, the press cake may be heated after mechanical desolventization.

According to a further embodiment, the press cake removed from the extractor or from the press is treated using a crusher ring, possibly in combination with a cake crusher, to minimize the particle size so that the extraction agent evaporates as completely as possible. At ambient pressure, the content of the extraction agent, for example isopentane, can be significantly reduced, as the remaining 10% of the extraction agent when using a screw press ensures cooling of the press cake via flash evaporation from 60° C. to approx. 30° C., which is just above the boiling temperature of the extraction agent (in this case isopentane) at ambient pressure.

In addition or as an alternative to the aforementioned options, in embodiments of the invention, a vacuum treatment of the press cake is carried out to remove any residual extraction agent.

In embodiments of the invention, the press cake is heated, for example to 60° C., since the temperature of the press cake drops to about 30° C. due to the flash evaporation of the extraction agent when the press cake exits the extractor into an area at ambient pressure, but the extraction agent can be better removed from the press cake at higher temperatures. Limiting the temperature to around 60° C. ensures gentle treatment of the press cake to guarantee the desired product quality.

In addition, the evaporating extraction agent can be easily collected in a vacuum chamber and fed to a recovery device for the extraction agent.

In embodiments of the invention, the press cake is heated using direct steam as a stripping medium (stripping).

At a pressure of 70 mbar a, which can be realized relatively easily with a water ring pump, the press cake degasses to an isopentane content of approx. 1000 ppm. For the desired limit value of max. 300 ppm isopentane in the press cake, a calculated pressure of approx. 20 mbar a is required. This pressure can be achieved with gas ejectors or dry vacuum pumps, for example. The above values are based on rapeseed press cake, as the extraction agent is particularly difficult to remove from this compared to sunflower seed press cake and soy press cake.

In order to achieve the usually required limit value of 300 ppm (0.03 %) of extraction agent residues remaining in the press cake, it may be necessary to subject the press cake to a stripping process. When stripping press cake, steam is usually passed through the cake, which carries most of the extraction agent with it. However, due to the desired low process temperatures, steam should not be used at atmospheric pressure. However, stripping can be carried out using nitrogen as the stripping medium without increasing the temperature.

However, if steam is to be used, it must be ensured that stripping takes place at approx. 60° C. and that the process pressure is low enough to prevent the water from condensing. This means that the process pressure must be below 0.2 bar a at 60° C.

The use of ambient air must be ruled out, as otherwise an explosive atmosphere could arise or there is an increased risk of fire.

The sequence of stripping and vacuum treatment can be varied and it is conceivable to dispense with one of the two processes if the desired limit value of extraction agent in the cake can be achieved with only one process in a specific set-up.

In embodiments of the invention, the extraction oil is subjected to the following post-treatment steps.

In a first embodiment, the trub oil/miscella that is removed from the extractor is passed through an oil dryer. This is particularly suitable if the extraction agent should not escape into the surrounding atmosphere.

Since the oil cools down when the extracting agent evaporates from the miscella and the remaining traces of the extracting agent in the oil can be removed more easily at higher temperatures, the oil is heated in embodiments of the invention.

The easiest way to heat the oil is in a steam-heated heat exchanger before it is injected into the oil dryer, where the pressure is higher than the vapor pressure of the extraction agent.

At a pressure of 70 mbar a, which can be realized relatively easily with a water ring pump, the oil degasses to an isopentane content of approx. 5300 ppm.

For the desired limit value of max. 300 ppm isopentane in the oil, a calculated pressure of approx. 3.5 mbar a is required. This pressure can be achieved with dry vacuum pumps, for example.

As an alternative or in addition to the oil dryer, the extraction oil can also be subjected to stripping. Usually, superheated steam is passed through the oil for this purpose. As the oil has to be heated to high temperatures during subsequent refining anyway and the PDI value of the oil is irrelevant, this can be done without hesitation.

Nevertheless, if gentle temperatures are required during oil processing, as is the case with mustard seed processing, for example (AITC content), the oil is treated in a stripping process with nitrogen or steam at a correspondingly low process pressure see the treatment of the press cake explained above.

In embodiments of the invention, recovery of the extractant is carried out.

The pure extraction agent isopentane condenses at 28° C. at atmospheric pressure in an aspiration system connected to the post-treatment system and surrounding the extractor. This temperature can be achieved with a standard cooling water system. However, it should be noted that this condensation temperature is the temperature at which the extractant condenses at the partial pressure of the extractant. This means that if inert gas is used, which may be required during start-up, for example, the condensation temperature drops accordingly.

Extracting agents that condense at lower temperatures may require more complex cooling using a chiller, or a compressor may be required to increase the pressure beforehand.

The water carried along with the aspiration condenses together with the extraction agent and must be removed from the system by separating the two liquid phases. Nitrogen as an inert gas does not condense and remains in the gas phase.

The pressing or pre-pressing of the oil-containing pressed material (usually oilseeds), which may be carried out prior to an extraction process according to the invention, is preferably carried out at temperatures of no more than about 60° C. in view of the objective of achieving the lowest possible process temperature throughout the processing process, the following methods being suitable:

1) A single-stage cold pre-compression without conditioning the seed, i.e. the seed heats up from approx. 20° C. to 60° C. in the screw press. This process does not require high temperatures at all. However, a relatively large amount of water remains in the press cake and oil removal during the pressing process is worse than with conditioned seed.

2) For better oil removal and less water in the oil and press cake, the seed can first be conditioned as usual. To achieve the desired effect, the temperature must be increased to approx. 100° C. during conditioning. The following options are then available for regulating the temperature in the press so that it is approx. 60° C. for the press cake at the outlet:

a) Nitrogen cooling of the screw press during the pressing process

b) Cooling during the pressing process by evaporating the extraction agent. In this process, the residual fat content in the press cake is also reduced by extraction during the pressing process.

c) Cooling during the pressing process using carbon dioxide as a pressing aid.

3) Conventional pre-pressing with conditioning of the seed and subsequent pressing without special cooling is also possible. However, temperatures of approx. 120-130° C. are reached inside the screw press, making this process the least suitable in terms of avoiding dwell times at high temperatures. The temperature of the press cake can be lowered to approx. 60° C. after the pressing process using a cake cooler.

Exemplary embodiments of the invention are shown in the figures explained below. They show:

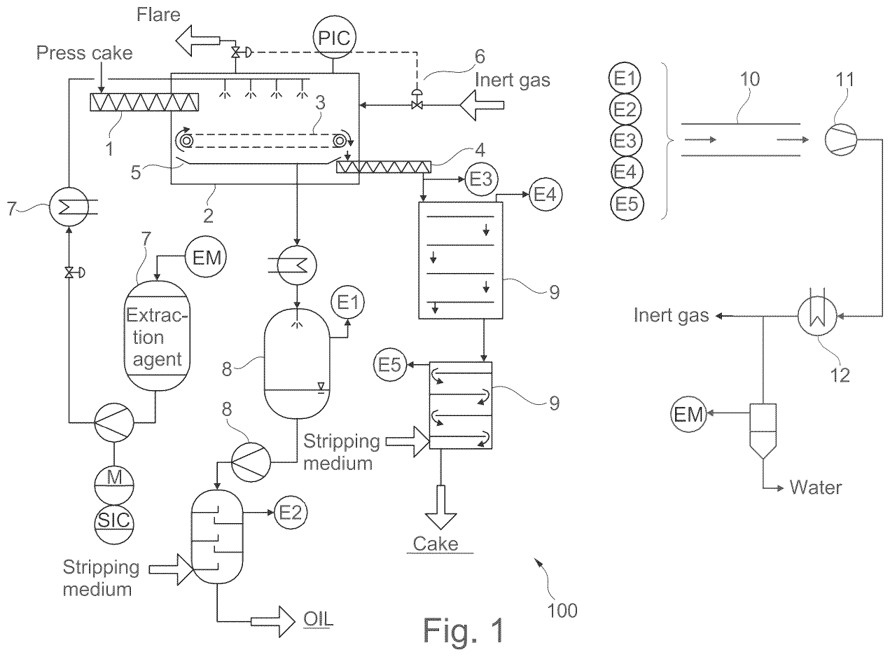

FIG. 1: A block diagram of a device for extraction according to the invention,

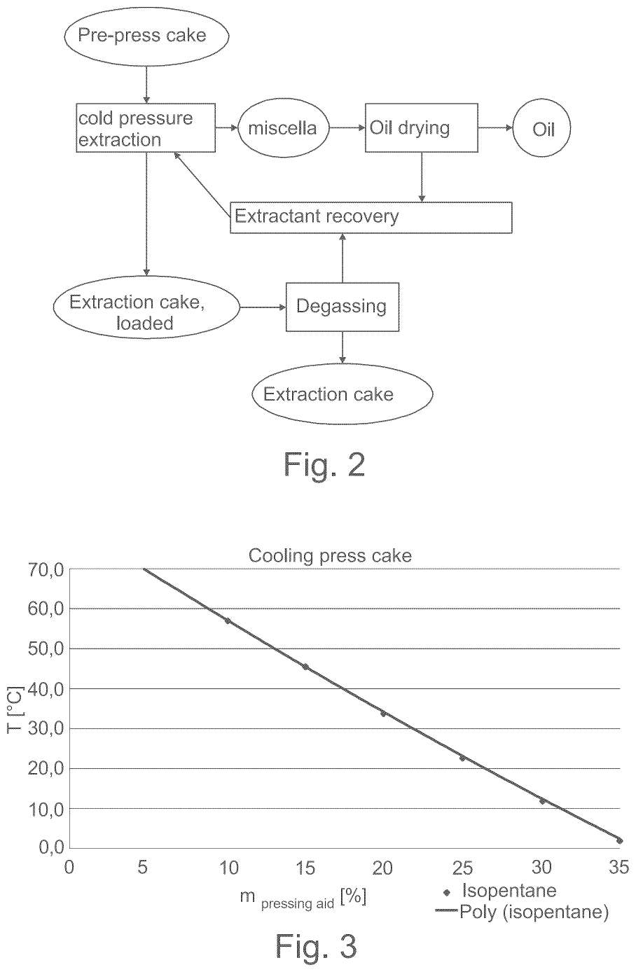

FIG. 2: A schematic diagram of the individual steps of an embodiment of a method according to the invention for extracting and

FIG. 3: A graphical representation of the cooling of the press cake as a function of the mass fraction of the extraction agent.

FIG. 1 shows a block diagram of an embodiment of a device for extraction (100) according to the invention.

The extraction device (100) has a feed device (1) for press cake or oilseeds, via which the press cake or oilseeds can be fed into the extraction chamber (2). A conveying device (3) for the press cake or oilseeds is arranged inside the extraction chamber (2). The press cake can be discharged from the extraction chamber (2) via the press cake discharge device (4).

A collecting device (5) for miscella is arranged below the conveying device (3) for the press cake, with which the oil extracted from the press cake or the oilseeds can be collected.

Means for generating and maintaining an overpressure (6) are functionally connected to the extraction chamber (2), which is designed as an overpressure chamber. In the present case, these are designed as an inert gas supply, via which an inert gas can be introduced into the extraction chamber (2) at a pressure. Furthermore, the inert gas supply has a controllable valve via which the inert gas supply can be adjusted.

Furthermore, the extraction device (100) has an extraction agent feed (7) with which an extraction agent can be fed into the extraction chamber (2). The extraction agent feed comprises an extraction agent metering unit, realized by a controllable valve, and a heat exchanger for adjusting the temperature of the extraction agent.

In addition, the extraction device (100) optionally has a post-treatment device for the extracted oil (8) and a second post-treatment device for the press cake (9).

In both post-treatment devices (8, 9), a stripping medium is added to the respective starting product of the actual extraction in order to remove extraction agent residues.

The extraction device (100) also has an aspiration system (10) with which vapors containing extraction agent can be tapped and collected at various points (E1 to E5).

Furthermore, the extraction device (100) has a recovery device for extraction agents, which is connected to the aspiration system (10) in such a way that the vapors containing extraction agents are fed to it.

In the embodiment shown, the extraction agent recovery device comprises a compressor (11) and a cooler/chiller (12) so that the extraction agent can be condensed and recovered.

FIG. 2 shows a schematic representation of the realized functional groups of an embodiment of a method for extraction according to the invention.

A pre-press cake is subjected to pressure extraction at low process temperatures between 50° C. and 80° C. The resulting miscella is subjected to oil drying to separate the oil from the extraction agent, whereby the extraction agent removed from the miscella is recovered for reuse in the extraction process.

The press cake loaded with extraction agent is post-treated for degassing so that the press cake and extraction agent are separated. The extraction agent is fed to the extraction agent recovery system.

FIG. 3 shows the cooling of the press cake as a function of the mass fraction of the extraction agent isopentane. As the mass fraction of extraction agent in the press cake increases, the press cake cools down more as the extraction agent evaporates. For safe storage of the press cake, a target temperature of the press cake of a maximum of around 45° C. is desirable. This temperature results from the faster perishability of food or pet food at higher temperatures and fire prevention, as the risk of spontaneous combustion of the press cake increases at higher temperatures due to the oil content.

With the usual mass fraction of about 30% extraction agent in the press cake after extraction, the press cake cools down to about 12° C. when the extraction agent isopentane vaporizes. With a mass fraction of about 10% isopentane in the press cake, which can be achieved, for example, by mechanically pressing the extraction agent out of the press cake, the press cake cools down to about 57° C.

For a target temperature of the press cake of 45° C., the mass fraction of isopentane is around 15%. This mass fraction can also be adjusted by mechanically pressing the extraction agent out of the press cake after extraction.

The actual cooling of the press cake can be assumed to be less than shown in the diagram, as the evaporation of the isopentane occurs when it leaves the extractor and the surrounding gas atmosphere and thus the exhaust air is also cooled.

If more extractant is to be added for better extraction, it may be necessary to increase the inlet temperature of the liquid extractant into the strainer so that the temperature does not drop further than desired.

1-15. (canceled)

16. An extraction device, comprising: a feed device for a press cake or oilseeds; an extraction chamber; a conveying device for the press cake or oilseeds within the extraction chamber; an extraction agent feed for feeding an extraction agent into the extraction chamber; a collecting device for miscella; and an oilseed or press cake outlet device, wherein the extraction chamber is an encapsulated overpressure chamber and both the feed device and the oilseed or press cake outlet are encapsulated so that extraction is carried out in the extraction chamber at an overpressure.

17. The device for extraction according to claim 16, wherein the extraction chamber is configured to carry out an extraction at an overpressure in a pressure range greater than or equal to 1.1 bar a.

18. The device for extraction according to claim 16, wherein the extraction agent feed includes a heat exchanger for adjusting input temperature of the extraction agent and an extraction agent metering unit for adjusting an amount of extraction agent.

19. The device for extraction according to claim 16, further comprising a recovery device for the extraction agent.

20. A method for extracting oil from oilseeds or a press cake, comprising the steps of: adding a liquid extraction agent to the oilseeds or press cake in an extraction chamber of a device for extraction, wherein the extraction agent is a fat dissolver; and carrying out the extraction under overpressure.

21. The method for extraction according to claim 20, wherein the extraction agent is at least partially non-polar.

22. The method for extraction according to claim 21, wherein the extraction agent is completely non-polar.

23. The method for extraction according to claim 20, wherein the extraction agent has a vapor pressure of 1.1-7 bar a at 60° C..

24. The method for extraction according to claim 20, wherein the extraction agent is n-butane and/or isopentane.

25. The method for extraction according to claim 23, including setting the overpressure in the extraction chamber at a selected process temperature to be at least equal to the vapor pressure of the extraction agent at the process temperature.

26. The method for extraction according to claim 20, including setting a process temperature in the extraction chamber of the device for extraction to between 50° C. and 80° C. during extraction.

27. The method for extraction according to claim 20, including adjusting a temperature of the extraction agent fed into the extraction chamber by using a heat exchanger.

28. The method for extraction according to claim 20, further including subjecting at least one of extracted oil and the press cake or the oilseeds to a post-treatment after extraction in the device for extraction, whereby extraction agent residues are removed.

29. The method for extraction according to claim 28, including limiting a process temperature in the post-treatment of the press cake to a maximum of 60° C.

30. The method for extraction according to claim 20, including recycling extraction agent evaporated and/or removed from the extracted oil and/or the press cake or the oilseeds after extraction using a recovery device.

31. The method for extraction according to claim 20, including using an extraction device, comprising: a feed device for a press cake or oilseeds; an extraction chamber; a conveying device for the press cake or oilseeds within the extraction chamber; an extraction agent feed for feeding an extraction agent into the extraction chamber; a collecting device for miscella; and an oilseed or press cake outlet device, wherein the extraction chamber is an encapsulated overpressure chamber and both the feed device and the oilseed or press cake outlet are encapsulated so that extraction is carried out in the extraction chamber at an overpressure.
